(19) United States
(12) Patent Application Publication
(10) Pub. No.: US 2009/0241841 A1
(43) Pub. Date: Oct. 1, 2009

(54) Directional control feeder with self-closing door and method of using same

(76) Inventors: B. Clyde Dollar, JR., Burnet, TX (US); Robert Croft, Ingram, TX (US)

Correspondence Address: THE MATTHEWS FIRM, 2000 BERING DRIVE, SUITE 700, HOUSTON, TX, 77057, US

(21) Appl. No.: 12/079,881

(22) Filed: Mar. 28, 2008

(51) Int. Cl. A01K 5/02; A01K 5/01

(52) U.S. Cl. 119/51.02; 119/57.1

(57) ABSTRACT

A directional control unit having a fan blade and a counter-weighted door. The fan blade is powered by a motor that spins the fan blade which disperses feed within the directional control unit and causes the counter-weighted door to open. The feed is then distributed solely through the counter-weighted door for distribution in preferably a single, predetermined direction and, at the same time, keeping varmints from getting into the control unit and stealing the feed.

### TECHNICAL FIELD

This invention relates to an apparatus and methods for dispensing feed to wildlife or livestock. More specifically, the present invention relates to dispersing feed preferably in a single direction through a counter-weighted, self-closing door, keeping varmints or other predators from stealing food.

### BRIEF DESCRIPTION OF DRAWINGS

FIG. 1A illustrates an isometric side view of an embodiment of the directional control feeder according to the invention.

FIG. 1B illustrates an isometric side view of the counter-weighted door in the closed position of an embodiment of the directional control feeder according to the invention.

FIG. 1C illustrates an isometric side view of the counter-weighted door in the open position of an embodiment of the directional control feeder according to the invention.

FIG. 2 illustrates an isometric front view of an embodiment of the directional control feeder attached to a hopper and a feed tube according to the invention.

FIG. 3 illustrates an isometric top view of an embodiment of the directional control feeder according to the invention.

FIG. 4 illustrates an isometric, pictorial front view of an embodiment of the directional control feeder according to the invention.

FIG. 5 illustrates an isometric front view of an embodiment of the directional control feeder according to the invention.

### DETAILED DESCRIPTION OF EMBODIMENTS OF THE INVENTION

For a further understanding of the nature and objects of the present invention, reference should be had to the following detailed description, taken in conjunction with the accompanying drawings, in which like elements are given the same or analogous reference numbers.

It is well known in the art that a variety of different feeders and methods for dispersing feed has been available for both wildlife and livestock, including but not limited to fish, animals, birds, etc. The hoppers typically used in such feeders vary from closed containers or drums to uncovered or semi-covered troughs and a variety of other containers that provide access to the various animals, livestock or wildlife. Further, the dispersing of the feed from the hopper has also varied from the use of spinners with low voltage power sources such as batteries to more sophisticated controls such as photoelectric cells, which may turn on the feeder at daylight or after dark, as well as, more straightforward methods such as simple holes in the bottom of the hopper that allow the feed to fall by gravity or open troughs or other open areas, in which, as soon as the feed is eaten more feed it is drawn by gravity to replace it. However, the prior art does not provide a method to disperse the feed in a predictable pattern, preferably in a single direction with a counter-weighted, self-closing door making it difficult for varmints or other predators to steal feed.

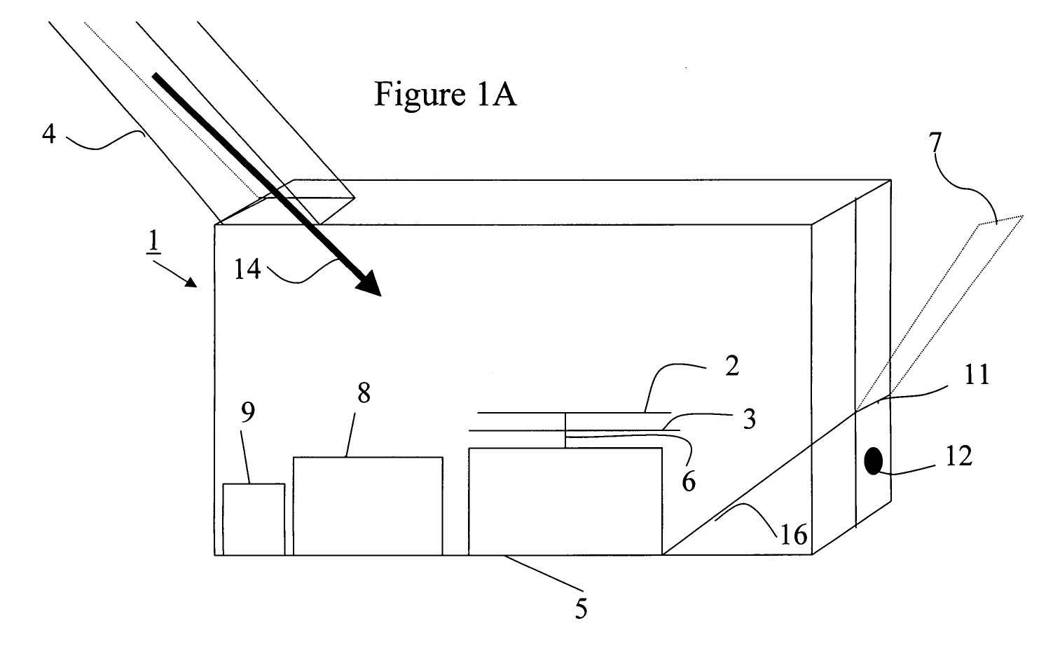

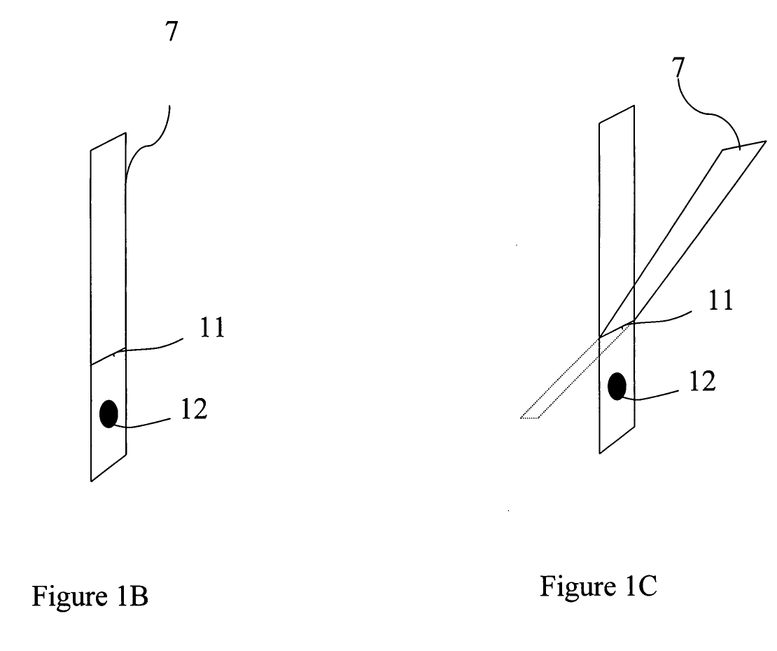

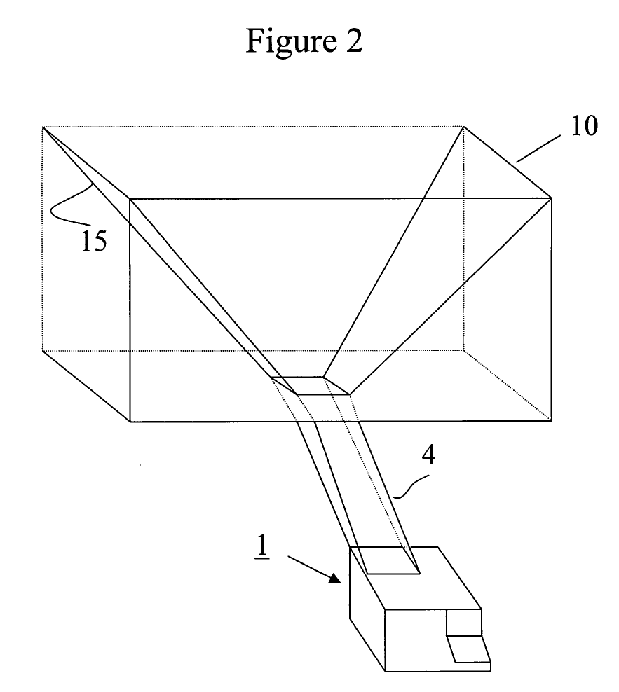

FIG. 1A represents an embodiment of a directional control feeder 1 according to the invention within which a fan blade 2 is installed and operates to disperse feed. The fan blade 2 may be shaped in any conventional way such as, but not limited to, an S-shaped, or a multi-finger fan blade (see co-pending U.S. patent application Ser. No. ______, titled Multi-Finger Spinner Feeder and Method of Using Same to Rieger), etc. The fan blade 2 is preferably mounted within the feeder 1 and directly above a tray 3 used to contain any feed that falls from the feed chamber 4. The tray 3 is preferably fixedly mounted above the motor 5 which operates to spin the fan blade 2. The motor shaft 6 preferably passes through the tray 3. Preferably, a feed chamber 4 is fixedly connected to the top of the directional control feeder 1 which allows for feed to pass from the hopper 10 (see FIG. 2) to the location of the fan blade 2 along the path indicated by the arrow 14. The size of the chamber 4 depends on the type and size of feed used in the particular feeder. When the motor 5 operates and causes the fan blade 2 to spin, the feed that falls through the feed chamber 4 strikes the self-closing, counter-weighted door 7 which opens in response to the pressure of the feed striking it. When this counter-weighted door 7 opens the feed flies out past the counter-weighted door 7 in preferably one predetermined direction. The tray 3 also functions to keep any feed that falls from the feed chamber 4 from falling below the height at which the counter-weighted door 7 opens. In order to direct the feed towards the counter-weighted door 7, there preferably will be a deflection plate 16 that keeps the feed from the bottom of the directional control feeder 1. If preferred, there might also be a deflection plate that keeps feed from the sides of the directional control feeder 1.

A battery 8, or some other conventional method such as, but not limited to, electricity, is used to operate the motor 5. It should be appreciated that the motor 5 may be any variety of conventional motors. Preferably the motor 5 is a digitally controlled motor having a controller therein, which can programed so as to control the operation of motor 5. Therefore, motor 5 may be programable to run for some predetermined time, such as, 10 seconds, 20 seconds, 30 seconds, etc and at a variety of times during the day, such as, 3 times a day, 4 times a day, 6 times a day, etc. It should be understood that the exact duration of motor 5 operation, as well as, the number of feedings or number of operations per day would be dependent on facts, such as but not limited to, the amount of wildlife or livestock to be fed, the type of wildlife or livestock to be fed, the time of year and feeding habits of the wildlife or livestock, as well as a variety of other feeding factors. It should be further understood, that other motors 5 may be used and as such it would be preferable to have a local controller 9 so as to allow the programming of the motor operation including cycle duration as well as number of cycles.

FIG. 1B represents the counter-weighted door 7 in the closed position of an embodiment of the directional control feeder according to the invention. The counter-weighted door 7 is preferably made of some lightweight but strong material such as, but not limited to, a strong metal, fiberglass, plastic, various composites, or any combination thereof. The counter-weighted door 7 is preferably rotatably attached to a hinge 11 and the hinge 11 is preferably fixedly mounted to the directional control feeder by welding or some other conventional connection device, for example, nuts and bolts, metal screws and the like. A counter-weight 12 is preferably fixedly attached to the counter-weighted door 7 below the hinge 11 by welding or some other conventional connection device, for example, nuts and bolts, metal screws and the like. The size and weight of the counter-weight 12 will depend upon the type of feed used in the directional control feeder. For example, when a smaller, lighter feed is used, the counter-weight 12 will have to be lighter and hence require less pressure to open the counter-weighted door 7.

FIG. 1 C represents the counter-weighted door 7 in the open position of an embodiment of the directional control feeder according to the invention.

FIG. 2 represents an embodiment of a directional control feeder 1 according to the invention in which the directional control feeder 1 is fixedly attached to a feed chamber 4 and the feed chamber 4 is fixedly attached to the hopper 10. Inside the hopper 10 is a funnel 15 with rectangular openings on each end which directs the feed toward the feed chamber 4. The hopper 10 is filled with feed and the feed then slides down the feed chamber 4 and into the directional control feeder 1.

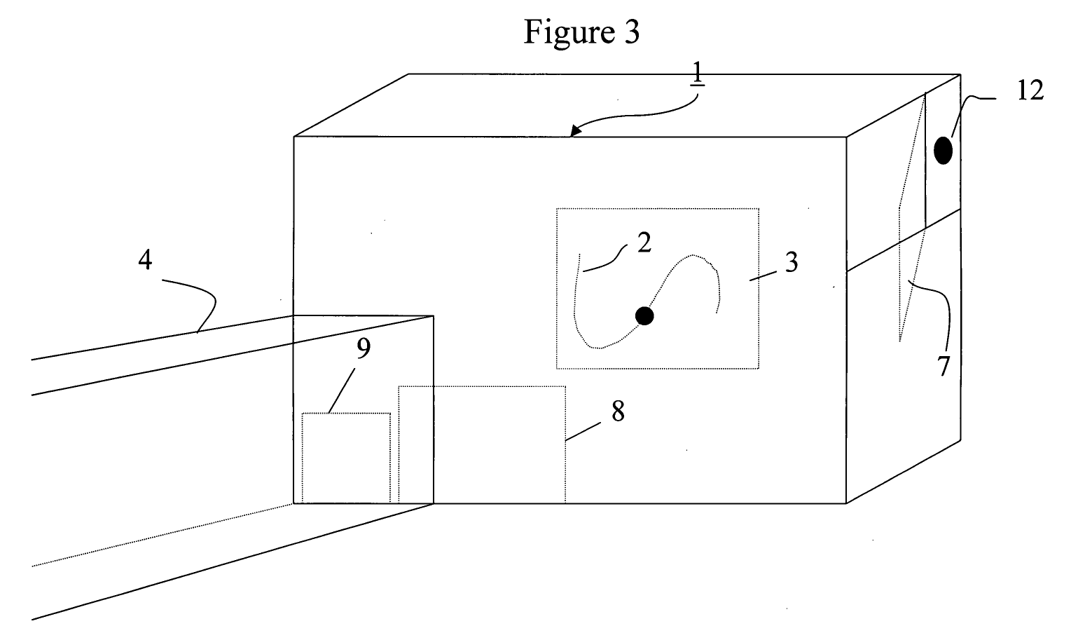

FIG. 3 represents a top view of an embodiment of a directional control feeder 1 according to the invention. The fan blade 2 is fixedly attached to the motor shaft 6 by welding or some other conventional connection device, for example, nuts and bolts, metal screws and the like. The location of the self-closing, counter-weighted door 7 and the position of the feed chamber 4 may also be identified in FIG. 3.

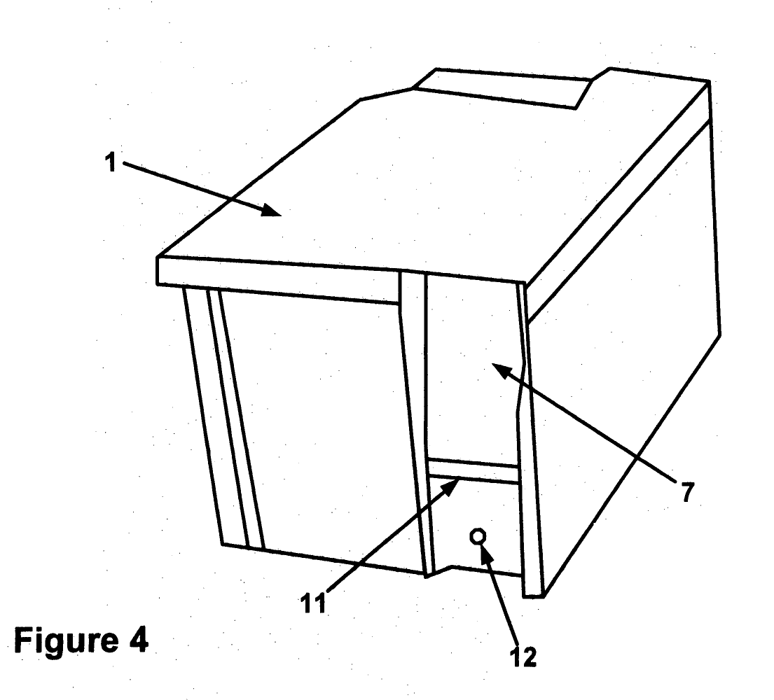

FIG. 4 represents a front view of an embodiment of the directional control feeder 1 according to the invention. The counter-weighted door 7 is preferably made of some lightweight but strong material such as, but not limited to, a strong metal, fiberglass, plastic, various composites, or any combination thereof. The counter-weighted door 7 is preferably rotatably attached to a hinge 11 and the hinge 11 is preferably fixedly mounted to the directional control feeder 1 by welding or some other conventional connection device, for example, nuts and bolts, metal screws and the like. A counter-weight 12 is preferably fixedly attached to the counter-weighted door 7 below the hinge 11 by welding or some other conventional connection device, for example, nuts and bolts, metal screws and the like. The size and weight of the counter-weight 12 will depend upon the type of feed used in the directional control feeder 1. For example, when a smaller, lighter feed is used, the counter-weight 12 will have to be lighter and hence require less pressure to open the counter-weighted door 7.

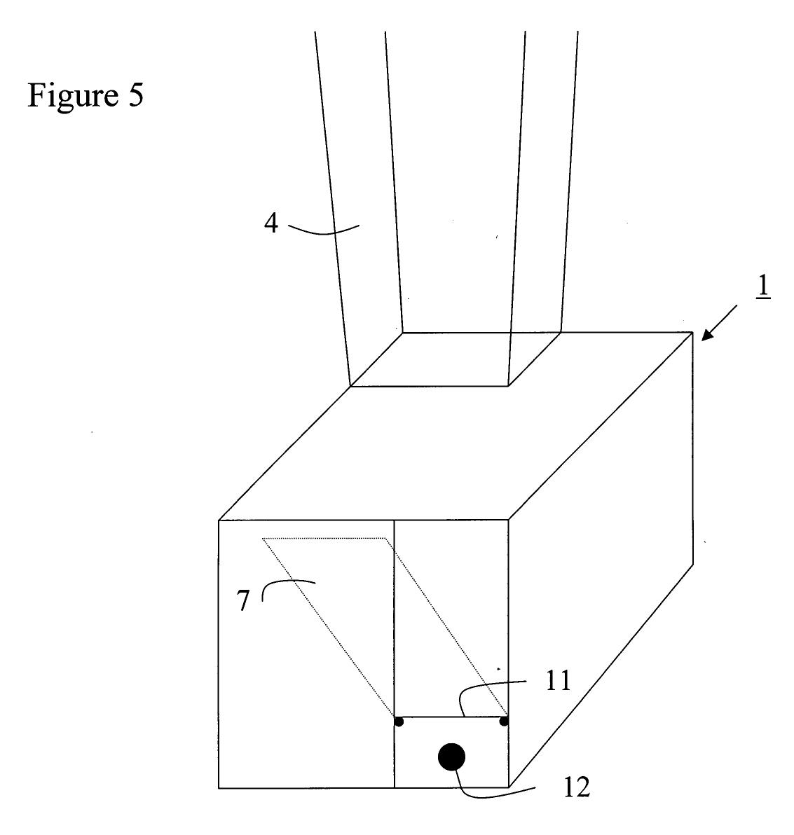

FIG. 5 illustrates the front of an embodiment of the directional control feeder 1 fixedly attached to the feed chamber 4. The location of the feed chamber 4 in relation to the counter-weighted door 7 can be seen in FIG. 5 as well as the location of the counter weight 12 and the hinge 11 used to attach the counter-weighted door 7 to the directional control feeder 1.

In operation, the hopper 10 is filled with feed. The feed falls from the hopper 10 through the feed chamber 4 and into the directional control unit 1. The feed is dispersed when the fan blade 2 begins to spin in response to the activation of the motor 5, which spins the motor shaft 6 attached fan blade 2. When the fan blade 2 begins to rapidly spin the feed, the feed strikes the inside of the counter-weighted door 7, which opens in response to the pressure of the feed striking it. When this counter-weighted door 7 opens the feed flies out past the counter-weighted door 7 in preferably one predetermined direction. When the fan blade 2 stops spinning and the feed is no longer striking the counter-weighted door 7, the counter-weighted door 7 closes due to the counter-weight 12 pulling down on the bottom of the counter-weighted door 7.

A battery 8, or some other conventional method such as, but not limited to, electricity, is used to operate the motor 5. It should be appreciated that the motor 5 may be any variety of conventional motors. Preferably the motor 5 is a digitally controlled motor having a controller therein, which can programed so as to control the operation of motor 5. Therefore, the motor 5 may be programable to run for some predetermined time, such as, 10 seconds, 20 seconds, 30 seconds, etc and at a variety of times during the day, such as, 3 times a day, 4 times a day, 6 times a day, etc. It should be understood that the exact duration of motor 5 operation, as well as, the number of feedings or number of operations per day would be dependent on facts, such as but not limited to, the amount of wildlife or livestock to be fed, the type of wildlife or livestock to be fed, the time of year and feeding habits of the wildlife or livestock, as well as a variety of other feeding factors. It should be further understood, that other motors 5 may be used and as such it would be preferable to have a local controller 9 so as to allow the programming of the motor operation including cycle duration as well as number of cycles.

1. A directional control unit for a feed dispensing apparatus comprising:
a tray positioned within the interior of said directional control unit, said tray having an underside and a top side;
a motor fixedly connected to the underside of said tray;
a rotating motor shaft being powered by said motor, wherein said motor shaft passes through said tray;
a fan blade fixedly fastened to said motor shaft;
wherein said motor causes said fan blade to rotate, and said fan blade moving feed from said tray;
a counter-weighted door, wherein said feed strikes the counter-weighted door causing it to open and allow feed to disperse in a single direction.

2. The directional control unit of claim 1, wherein said motor is digitally controlled to allow for the programming of said motor operation.

3. The directional control unit of claim 1, further comprising a controller to allow the programming of said motor operation.

4. The directional control unit of claim 1, further comprising a battery for supplying power to said motor.

5. The directional control unit of claim 1, wherein said counter-weighted door is fixedly attached to a counter-weight and rotatably attached to a hinge.

6. A method for dispersing feed comprising:
providing a tray positioned within the interior of said directional control unit, said tray having an underside and a top side;
providing a motor fixedly connected to the underside of said tray;
providing a rotating motor shaft being powered by said motor, wherein said motor shaft passes through said tray;
providing an blade fixedly fastened to said motor shaft;
said motor causing said blade to rotate;
said fan blade moving feed from said tray;
providing a counter-weighted door, wherein said feed strikes the counter-weighted door causing it to open and to allow feed to disperse in a single direction.

7. The method of claim 6, wherein the motor is digitally controlled to allow for the programming of the motor operation.

8. The method of claim 6, further providing a controller to allow for the programming of said motor operation.

9. The method of claim 6, further providing a battery for supplying power to said motor.

10. The method of claim 6, wherein said counter-weighted door is fixedly attached to a counter-weight and a hinge.
